(19) United States
(12) Patent Application Publication
(10) Pub. No.: US 2005/0144917 A1
(43) Pub. Date: Jul. 7, 2005

(54) Air cleaner element

(75) Inventors: Atsushi Suzuki, Hamakita-shi (JP); Kunimoto Sugiyama, Shizuoka (JP); Toshinori Oba, Shizuoka (JP)

Correspondence Address: YOUNG & THOMPSON, 745 SOUTH 23RD STREET, 2ND FLOOR, ARLINGTON, VA, 22202, US

(73) Assignee: TOYO ROKI SEIZO KABUSHIKI KAISHA, HAMAKITA-SHI (JP)

(21) Appl. No.: 10/503,542

(22) PCT Filed: Feb. 7, 2003
(86) PCT No.: PCT/JP03/01340

(30) Foreign Application Priority Data
Feb. 8, 2002 (JP) 2002-33101

(51) Int. Cl. B01D 46/00

(52) U.S. Cl. 55/486

(57) ABSTRACT

An air cleaner element is provided which is capable of improving a dust penetrating performance (that is, capable of reducing a penetrating amount of the dust, once captured, as an amount released from a filter member due to an air flow pulsation), while maintaining dust and carbon capturing performances of a density gradient type non-woven fabric. The filter member 1 of the air cleaner element includes a first filter layer 3 formed of a non-woven fabric, and a second filter layer 4 disposed on the downstream side of the first filter layer 3 with respect to an air flow direction, and formed of a non-woven fabric having a fine mesh structure in comparison with that of the first filter layer 3. The first filter layer 3 is impregnated with an oil. The second filter layer 4 has an oil repellent property.

### TECHNICAL FIELD

The present invention relates to an air cleaner element for an internal combustion engine of, for example, an automobile.

### BACKGROUND ART

As an air cleaner element for an internal combustion engine of an automobile or like, there is known an air cleaner element (for example, refer to the following Patent Publication 1, page 1), in which a filter member is formed, in an arrangement of chrysanthemum, of a non-woven fabric of density gradient type having coarse and dense layers, and fixed by means of frame. The filter member formed of the density gradient type non-woven fabric has a suitable density gradient from the coarse layer to the dense layer in accordance with particle distribution of dust to be captured by the filter member. The coarse layer on an external air flow-in side mainly acts to selectively capture dusts each having a large particle diameter, and on the other hand, the dense layer on the external air flow-out side acts to capture dusts, mainly composed of carbon particle, each having a small particle diameter.

[Patent Publication 1]: Japanese Patent Laid-open Publication No. SHO 56-107950

According to the use of the filter member formed of the density gradient type non-woven fabric, dusts can be efficiently captured selectively by the respective layers at a good balance of the respective layers to thereby substantially suppress the increasing of ventilation resistance of the filter member.

### DISCLOSURE OF THE INVENTION

An object of the present invention is to improve an air cleaner element formed of a density gradient type non-woven fabric with its performance being maintained. Specifically, an object of the present invention is to provide an air cleaner element capable of, while maintaining dust and carbon capturing performance of a density gradient type non-woven fabric, improving dust permeability (i.e., reducing dust penetrating amount of the dust once captured and then released from a filter member through pulsation of air flow).

The present invention can achieve the above object by providing an air cleaner element comprising a first filter layer formed of a non-woven fabric, and a second filter layer disposed on the downstream side of the first filter layer with respect to an air flow direction and formed of a non-woven fabric having a fine mesh structure in comparison with that of the first filter layer, in which the first filter layer is impregnated with an oil, and the second filter layer has an oil repelling property.

According to this invention, by impregnating the first filter layer with an oil, the dust once captured can be suppressed from releasing thereform. In addition, by locating the second filter layer having an oil repellent property, the oil impregnated in the first filter layer can be prevented from moving towards the second filter layer. Therefore, the dust penetrating amount, i.e., an amount of the dust, once captured, to be released from the filter member, can be reduced.

It is preferred that the first filter layer has a laminated layer structure including a plurality of layers in which one layer has a rough (coarse) mesh structure in comparison with another downstream layer, and the first filter layer has a thickness larger than that of the second filter layer.

According to this preferred aspect of the invention, since the first filter layer is composed of a plurality of layers to thereby ensure the dust capturing amount without increasing the ventilation resistance. In addition, by making the thickness of the first filter layer larger than that of the second filter layer, the first filter layer allows the dust and carbon to be captured relatively much in amounts.

### BRIEF DESCRIPTION OF THE DRAWINGS

FIG. 1 is a sectional view showing an embodiment of an air cleaner element according to the present invention.

FIG. 2 is a sectional view showing a filter member.

FIGS. 3A, 3B, and 3C are perspective views representing another embodiment of the air cleaner element (FIGS. 3A and 3B show an example of a filter member bent in the shape of panel, and FIG. 3C shows an example of the filter member expanded in flat shape).

FIGS. 4A, and 4B are perspective views of still another example of a filter member (FIG. 4A shows an example having a tubular shape, and FIG. 4B shows an example having a chrysanthemum shape).

FIG. 5 is a graph representing a performance of a filter member of the embodiment of the present invention in comparison with a comparative example.

FIG. 6 shows a structure of a filter member of a comparative example.

### PREFERRED EMBODIMENTS FOR CARRYING OUT THE INVENTION

Hereunder, an embodiment of an air cleaner element according to the present invention will be described with reference to the accompanying drawings.

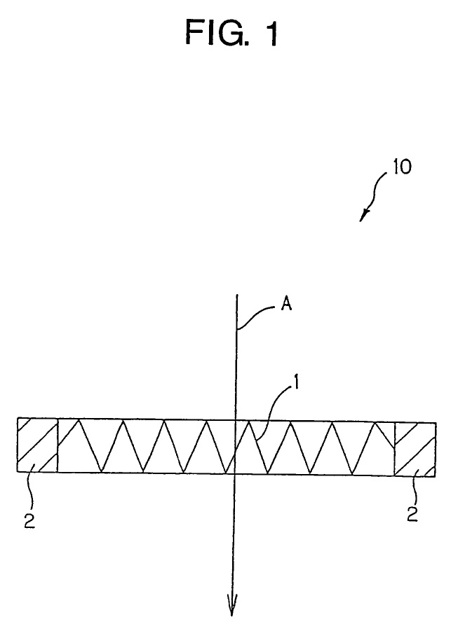

An air cleaner element 10 shown in FIG. 1 is composed of a folded filter member 1, and a rectangular frame member 2 made of plastic in which the filter member 1 is accommodated and held. As shown in FIG. 1, the filter member 1 is insert-molded at its peripheral portion into the frame member 2 so as to be fixed thereto.

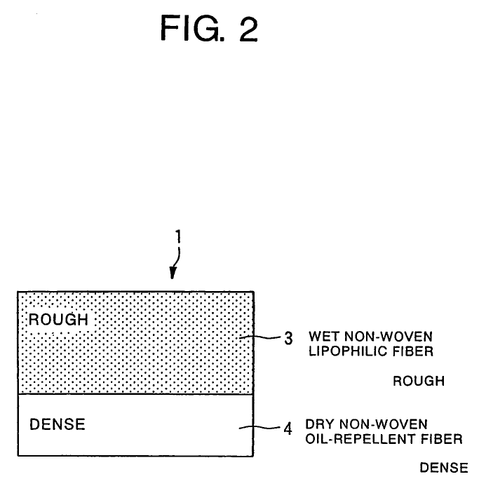

FIG. 2 shows the filter member 1. The filter member 1 comprises a first filter layer 3 disposed on the upstream side and formed of non-woven fabric, and a second filter layer 4 disposed on the downstream side and also formed of non-woven fabric. The first filter layer 3 provides a rough mesh structure, and the second filter layer 4, on the other hand, provides a fine mesh structure in comparison with the first filter layer 3. The first filter layer 3 is impregnated with oil and the second filter layer 4 is never impregnated with oil, and the second filter layer 4 has dry-type structure which is provided with an oil repelling property

The first filter layer 3 has a thickness larger than that of the second filter layer 4. Further, the first filter layer 3 is composed of a plurality of, for example, 2 to 4, layers stacked in such a manner that one upstream side layer has a rough mesh structure in comparison with another downstream side layer. The reason why the first filter layer 3 has the thickness larger than that of the second filter layer 4 is to capture much amount of dust and carbon, (that is, the reason does not reside in that the dust and carbon are captured by a surface area such as in a filter paper, but resides in that much dust and carbon can be captured by the volume including thickness). In addition, the reason why the first filter layer 3 is composed of a plurality of layers resides in that the amount of captured dust and carbon can be ensured without increasing ventilation resistance.

As a material for constituting the first filter layer 3, there will be used a non-woven fabric. The non-woven fabric is a cloth which is formed of synthetic fibers by binding, heat-pressing, sewing, and irregularly arranging the fibers or making them tangled. The non-woven fabric for forming the first filter layer 3 includes lipophilic fibers such as polyethylene terephthalate (PET), polyester, polyamide or the like.

The first filter layer 3 is impregnated with an oil such as viscous oil. On the upper surface of the first filter layer 3, the oil impregnated in the first filter layer 3 oozes to thereby provide a state capable of easily capturing the dust. That is, after the dust has been captured by oil on the surface of the first filter layer 3, by further penetrating oil into the captured dust, there causes a function for further capturing the next dust on the surface of the captured dust.

Non-woven fabric is also utilized for the material of the second filter layer 4. The non-woven fabric forming this second filter layer 4 is added with oil repellent (repelling) fibers. Fluorine-contained fibers, fibers coated with fluorine or like fibers may be used as the oil repellent fibers. The fluorine may be utilized as a binder. The oil repellent fibers can suppress the oil in the first filter layer 3 from moving to the second filter layer 4.

The impregnation of the oil into the first filter layer 3 can suppress the captured dust from being released from the first filter layer 3. In addition, the oil contained in the first filter layer 3 is suppressed from moving into the second filter layer 4 by the oil-repellent property of the second filter layer 4. Because of this reason, the penetrating amount of the dust, which is once captured by the pulsation of the air flow and discharged from the filter member 1, can be effectively reduced.

The second filter layer 4 has a dense structure in comparison with the first filter layer 3. Specifically, for example, each of the fibers forming the second filter layer 4 has a diameter smaller than that of the first filter layer 3, and the aperture of the fibers, including the binder, of the second filter layer 4 is made smaller than that of the first filter layer 3. Furthermore, the second filter layer 4 is composed of a plurality of layers, for example, 1 to 3 layers, which are stacked such that a layer disposed on the upstream side of the air flow has rough mesh structure in comparison with another layer disposed on the downstream side thereof. The dust or carbon capturing efficiency of the filter member can be regulated by adjusting the aperture, fiber diameter, binder amount, thickness, layer structure, or the like of the second filter layer 4.

In a case where an air cleaner element according to the embodiment of the present invention is used as an air cleaner element for a vehicle, the thickness of the first filter layer 3 will be set to 0.4 to 1.7 mm, and that of the second filter layer 4 will be set to 0.1 to 0.8 mm, for example. On the other hand, the thickness of the entire structure of the filter member 1 will be set to be thinner than that of a filter member formed of conventional density gradient type non-woven fabric in consideration of freedom of layout, and it will be set, for example, to 1.0 to 1.5 mm. The thickness of the first filter layer 3 and that of the second filter layer 4 will be determined to optimum values in consideration of the capturing amounts of dust and carbon of the capturing efficiency thereof, and the oil blow-by property.

The bonding or joining between the first and second filter layers 3 and 4, between the respective layers of the first filter layer 3, and between the respective layers of the second filter layer 4 is performed by impregnating the binder into the surfaces to be bonded, and using a needle punch for tangling respective fibers. In the other methods, these layers may be bonded by arranging molten fibers such as low-melting point fibers into the fibers of the respective layers and then bonding them together, fusing them together, using bonding agents, and utilizing these methods in combination.

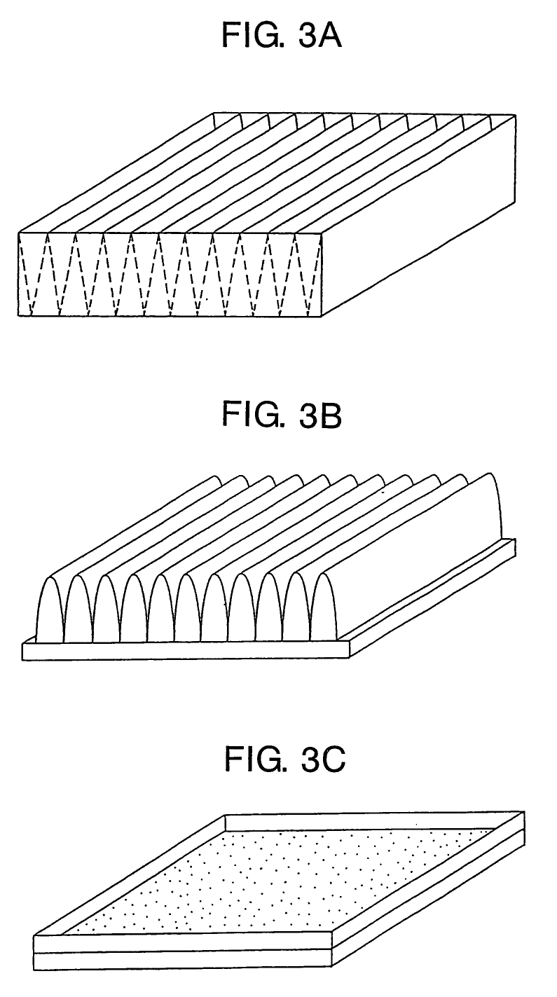

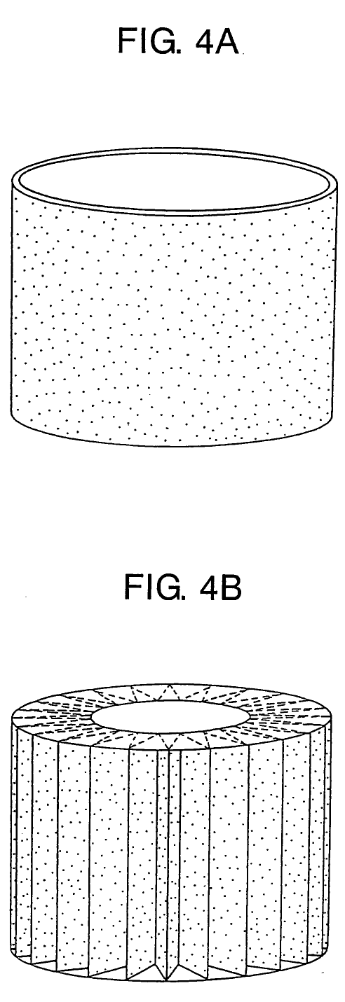

In the described embodiment of the present invention, although, as shown in FIG. 1, the filter member 1 in the bent form is utilized for increasing the actual surface area of filter, the filter member 1 may be used in the expanded flat shape as shown in FIG. 3C. Further, FIGS. 3A and 3B show examples in which the filter member 1 is folded and bent to provide a panel-type filter. Furthermore, the filter member 1 may be freely formed so as to have various shapes such as, for example, as shown in FIGS. 4A and 4B, the filter member 1 is formed into a tubular structure or chrysanthemum shape to flow the air from the inside of the tubular structure toward the outside thereof or vice versa.

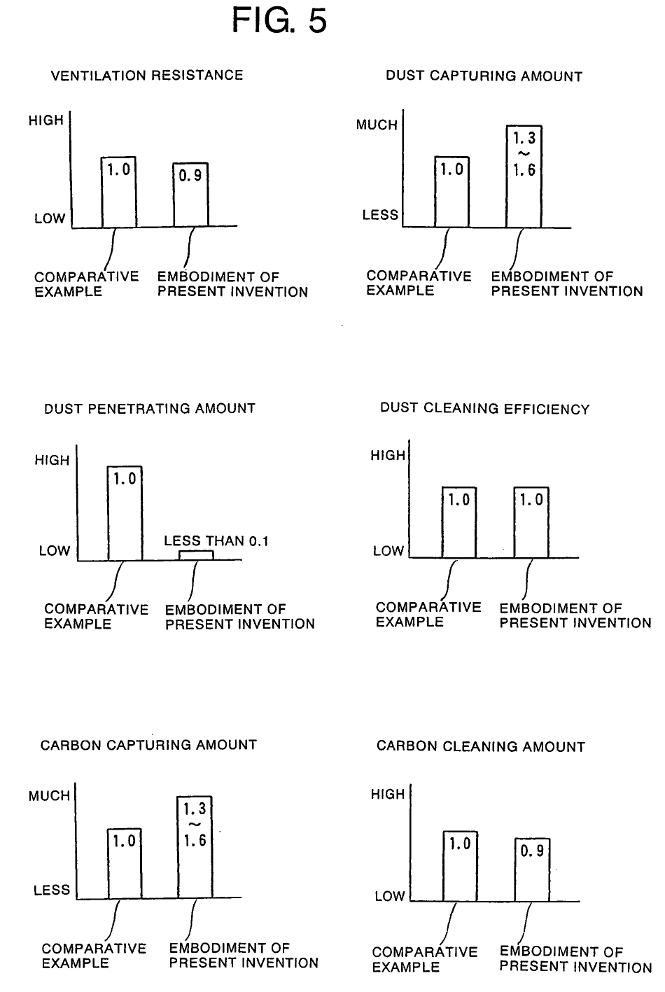

FIG. 5 includes illustrated graphs showing performances of the filter member according to the embodiment of the present invention in comparison with a comparative example (i.e., density gradient type filter member of conventional structure), and herein, a case in which an air cleaner element is incorporated in an intake path of the engine is assumed.

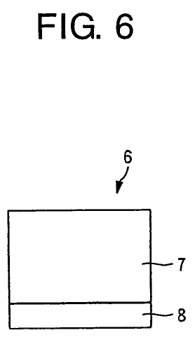

FIG. 6 shows a structure of the filter member of the comparative example. The filter member 6 of the comparative example is composed of a first filter layer 7 formed of a non-woven fabric of polyester fibers, and a second filter layer 8 formed of a non-woven fabric of polyester fibers. The first filter layer 7 is formed with a rough mesh structure, and the second filter layer 8 is, on the other hand, formed with a fine mesh structure. A thickness of the first filter layer 7 is set to be around 2 mm, and that of the second filter layer 8 is set to be around 0.5 mm. Further, both the first and second filter layers 7 and 8 are not impregnated with oil.

The performances of the filter members according to the embodiment of the present invention will be described with respect to the items shown in FIG. 5.

(Ventilation Resistance)

According to the embodiment of the present invention, since the thickness of the filter member can be made thin, the filter member 1, for example, can be easily folded and bent in the zigzag form, thus providing a wide filtering surface area. Accordingly, the ventilation resistance can be reduced in comparison with the comparative example. Further, it is considered that the ventilation resistance of the unit of the filter member according to the embodiment of the present invention is not so different from that of the comparative example.

(Dust Capturing Amount (Rate))

According to the embodiment of the present invention, the dust is captured by the oil existing on the surface of the first filter layer 3, and thereafter, the oil further penetrates through the thus captured dust, which causes a function of capturing the next dust on the surface of the captured dust (so called, generation of dust-cake layer). The dust capturing amount can be increased by the addition of the capturing function specific to the volume of the non-woven fabric to the capturing function of the dust-cake layer.

(Dust Penetrating Amount)

By exchanging the first filter layer 3 from a dry type one to a wet type one, the captured dust can be suppressed from releasing therefrom, thus reducing the dust penetrating amount. This dust penetrating amount is an amount of the dust, which was once captured, penetrating to the downstream side of the filter member due to the pulsation of the air or the like, and hence, depends on pulsation magnitude, pulsation frequency, flow velocity and the like. In the present embodiment, the movement of the dust due to the pulsation of the airflow can be prevented by forming the first filter layer 3 to be the wet type one.

(Dust Cleaning Efficiency)

The dust cleaning efficiency will be expressed as “dust cleaning efficiency”=“dust capturing amount (g) by filter member”/“dust capturing amount (g) by filter member+amount (g) of dust penetrating filter member”. The dust cleaning efficiency is influenced with the flow velocity of the air passing the filter member and the aperture thereof. In the present embodiment, there was shown no significant difference in the dust cleaning efficiency from the comparative example.

(Carbon Capturing Amount)

The non-woven fabric itself has a high carbon capturing performance. According to the filter member 1 of the embodiment of the present invention, the thickness of the filter member can be made thin, which will result in enlarged filtering area. Because of this reason, the carbon capturing amount can be improved.

(Carbon Cleaning Efficiency)

The carbon cleaning efficiency will be expressed as “carbon cleaning efficiency”=“carbon capturing amount (g) by filter member”/“carbon capturing amount (g) by filter member+amount (g) of carbon penetrating filter member”. The carbon cleaning efficiency is influenced with the flow velocity of the air passing the filter member and the aperture thereof. In the present embodiment, there was shown no significant difference in the carbon cleaning efficiency from the comparative example.

As mentioned hereinabove, according to the present invention, the releasing of the captured dust from the first filter layer can be suppressed by impregnating the first filter layer with the oil. In addition, the second filter layer having the oil repellent property can prevent the oil in the first filter layer from entering the second filter layer. Therefore, the dust penetrating amount, which corresponds to an amount of the dust, which is once captured, to be released from the filter member, can be reduced.

1. An air cleaner element comprising:
a first filter layer formed of a non-woven fabric; and
a second filter layer disposed on the downstream side of the first filter layer with respect to an air flow direction, and formed of a non-woven fabric having a fine mesh structure in comparison with that of the first filter layer,
said first filter layer being impregnated with oil, and
said second filter layer having an oil repellent property.

2. An air cleaner element according to claim 1, wherein said first filter layer has a laminated layer structure including a plurality of layers in which one layer has a rough mesh structure in comparison with another downstream layer, and said first filter layer has a thickness larger than that of the second filter layer.
